(19) United States
(12) Patent Application Publication
(10) Pub. No.: US 2012/0127512 A1
(43) Pub. Date: May 24, 2012

(54) BRANCH OFFICE DIRECT PRINTING

(75) Inventors: Jonathan Kay, Redmond, WA (US); Jeffrey Ermak, Kirkland, WA (US); Joshua Dersch, Lynnwood, WA (US); Adrian Maxa, Kirkland, WA (US); Alan Morris, Bellevue, WA (US); Ravi Rao, Redmond, WA (US)

(73) Assignee: Microsoft Corporation, Redmond, WA (US)

(21) Appl. No.: 12/950,337

(22) Filed: Nov. 19, 2010

(51) Int. Cl. G06F 3/12

(52) U.S. Cl. 358/1.15

(57) ABSTRACT

Methods and apparatus for printing by a client computer reduce network usage and print delay, while performing print configuration and management at a centralized print server. The print server controls enablement of a branch office printing mode. When the branch office printing mode is enabled, the client computer sends spooled print data directly to a selected printer in the branch office. When the branch office printing mode is disabled, the client computer sends the spooled print data to the centralized print server, and the print server routes the print data to the selected printer. The print server performs configuration and management functions for the client computer in both operating modes. The print server may enable and disable the branch office printing mode on a per queue basis.

### BACKGROUND

Large organizations may consolidate management of printing in a print server located in a central office. A centralized print server facilitates printer configuration and management. When such systems are used, a client computer in a branch office sends a print job to a remote spooler on the print server. The print server then sends the print job to a local printer in the branch office. This creates a situation where print jobs are sent on the network to the print server at headquarters and then are routed back to a printer in the branch office. Such operation is wasteful of expensive wide area network bandwidth and, particularly on high latency links, slows down the print job.

Accordingly, there is a need for printing methods and apparatus which retain the advantages of a centralized print server but overcome one or more of the problems which result from routing print jobs through the centralized print server.

### SUMMARY

In accordance with embodiments of the invention, methods and apparatus for printing by a client computer reduce network usage and print delay, while performing printer configuration and management at a centralized print server. The print server controls enablement of a branch office printing mode. When the branch office printing mode is enabled, the client computer sends spooled print data directly to a selected printer in the branch office. When the branch office printing mode is disabled, the client computer sends the spooled print data to the centralized print server, and the print server routes the print data to the selected printer. The print server performs configuration and management functions for the client computer in both operating modes. The print server may enable and disable the branch office printing mode on a per queue basis.

According to a first aspect of the invention, a method is provided for printing by a client computer. The method comprises receiving, by a client computer from a user, a print request; determining, by the client computer from a print server, if a branch office printing mode is enabled; if the branch office printing mode is determined to be enabled, the client computer executing the print request by printing directly to a selected printer; and if the branch office printing mode is determined to be disabled, the client computer executing the print request by printing to the selected printer through the print server.

According to a second aspect of the invention, a client computer is configured to execute a print request. The client computer comprises a processor and a memory device, the memory device including: a print spooler to hold print data, to receive a print request, to determine from a print server if a branch office printing mode is enabled, if the branch office printing mode is determined to be enabled, to proceed with printing by sending the print data directly to a selected printer, and if the branch office printing mode is determined to be disabled, to proceed with printing by sending the print data to the selected printer through the print server.

According to a third aspect of the invention, a method is provided for controlling printing by a print server. The method comprises receiving, by a print server from an administrator, a branch office printing mode selection for a specified print queue; enabling, by the print server, the branch office printing mode for the specified print queue; receiving, by the print server, an indication of a print request from a client computer; and notifying, by the print server, the client computer that the branch office printing mode is enabled.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic block diagram of a conventional computer system, illustrating printing through a centralized print server;

FIG. 2 is a schematic block diagram of a computer system, in accordance with embodiments of the invention, wherein spooled print data is sent directly from a client computer to a local printer;

FIG. 3 is a schematic block diagram of a computer system, in accordance with embodiments of the invention, illustrating components of the client computer and the print server;

FIG. 3A is a schematic block diagram showing a client print spooler and a printer, in accordance with embodiments of the invention;

FIG. 4 is a flow chart of a process performed by a client computer, in accordance with embodiments of the invention;

FIG. 5 is a schematic block diagram of a computer system, in accordance with embodiments of the invention, illustrating operation of different print queues;

FIG. 6 is a flow chart of a process performed by a print server, in accordance with embodiments of the invention; and

FIG. 7 is a schematic block diagram of a computing device that may be implemented as a client computer or as a print server.

### DETAILED DESCRIPTION

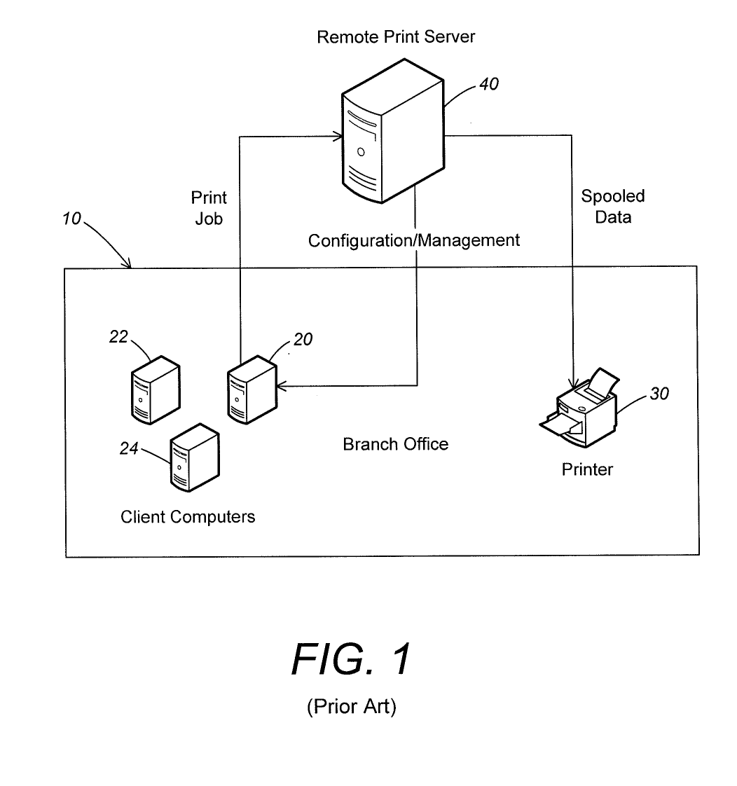

A schematic block diagram of a conventional computer system utilizing a remote print server is shown in FIG. 1. A company or other entity may have offices at two or more geographical locations. A branch office 10 may include client computers 20, 22, 24, etc., and a printer 30. A headquarters office or other office may include a remote print server 40 that controls printing by client computers 20, 22, 24 to printer 30.

In operation, computing device 20 receives a request for a print job from a user. The client computer 20 notifies the remote print server 40 of the print request and sends the print data, also known as spooled data, to remote print server 40. The remote print server 40 then sends the spooled data for the print job to printer 30 for printing. The remote print server 40 controls print configuration and management for each of client computers 20, 22 and 24. As indicated above, sending the print job to the remote print server 40 and then back to the printer 30 in the branch office 10 may be wasteful of network bandwidth and may result in printing delays.

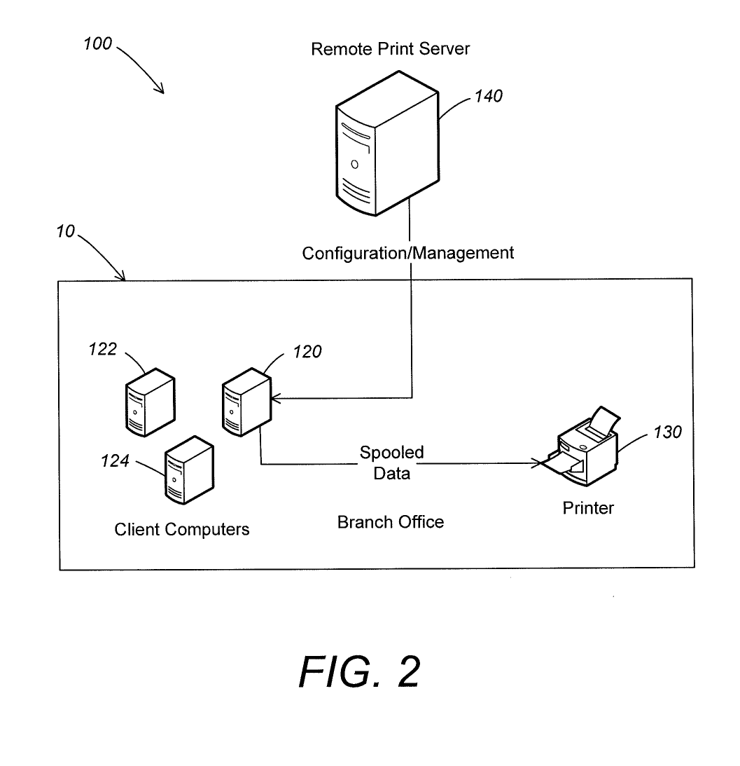

A schematic block diagram of a computer system 100 in accordance with embodiments of the invention is shown in FIG. 2. Branch office 10 may include client computers 120, 122, 124, etc., and a printer 130. A headquarters office or other office may include a remote print server 140.

The components of computer system 100 relevant to the operation of the present invention are shown in FIG. 2. It will be understood that the branch office 10 may include more or fewer client computers, additional printers and other components known to those skilled in the art. Furthermore, the headquarters office may include components in addition to remote print server 140. Also, the computer system 100 may include more than one branch office and more than one print server. The branch office 10 and the remote print server 140 are typically at different geographical locations, although this is not a requirement for operation of the present invention.

In accordance with embodiments of the invention, the print server 140 controls enabling and disabling of a branch office printing mode. When the branch office printing mode is enabled by print server 140, client computer 120 sends spooled print data directly to printer 130 in branch office 10. When a print request is received from a user by client computer 120, client computer 120 sends an indication of the print request to print server 140. Print server 140 determines if the branch office printing mode has been enabled for printer 130 and notifies client computer 120 accordingly. When the branch office printing mode is enabled, client computer 120 sends spooled print data directly to printer 130. The spooled print data is not sent by client computer 120 to remote print server 140 in the branch office printing mode. Print server 140 controls print configuration and management for client computer 120. Branch office printing is described in greater detail below.

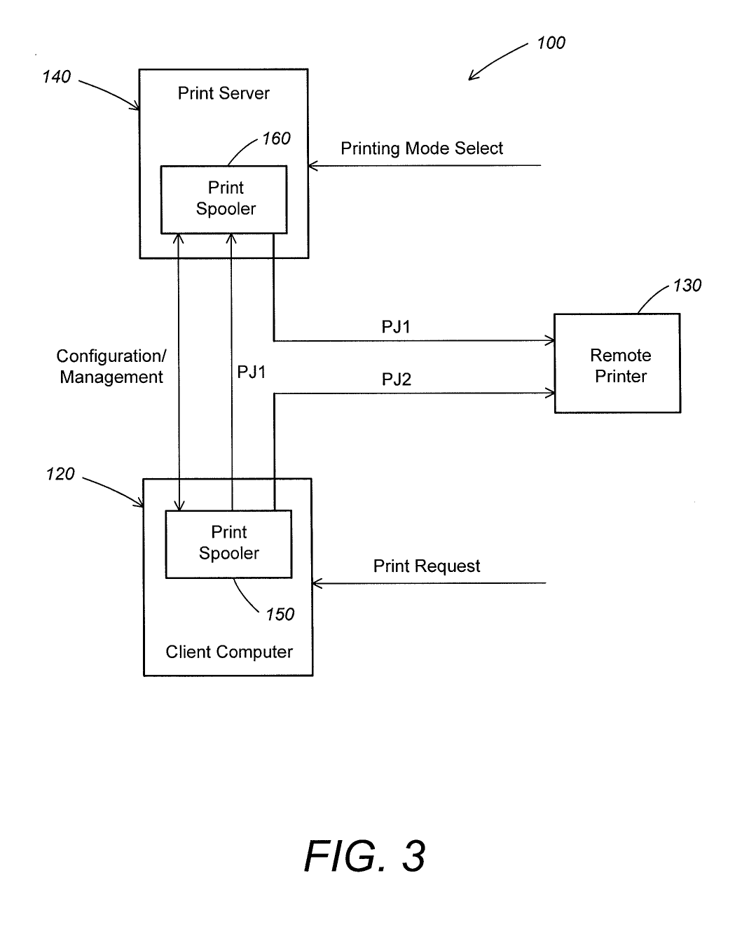

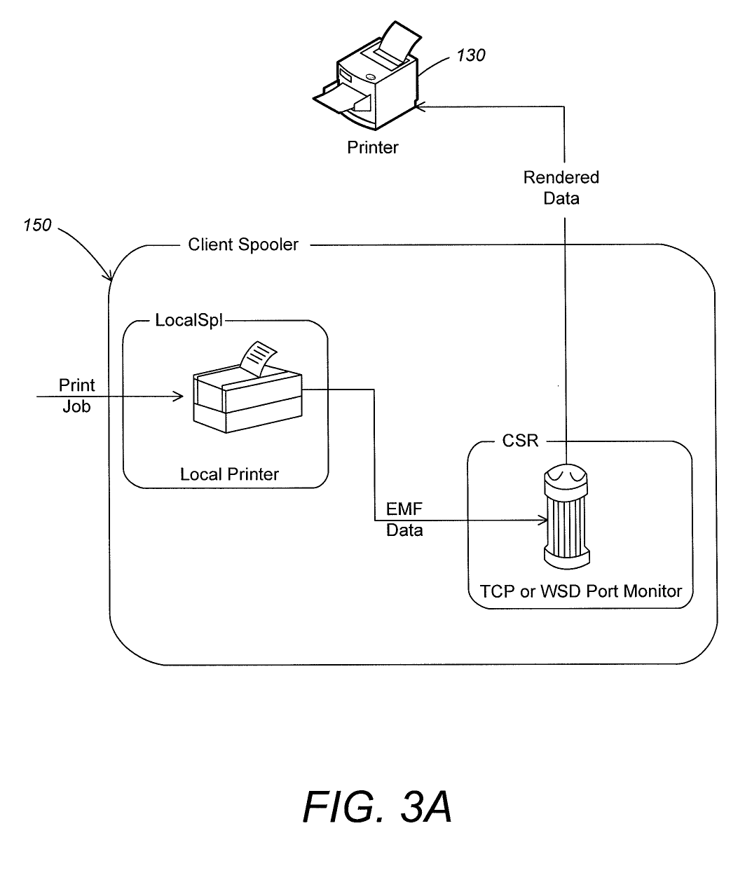

The computer system 100 is shown in greater detail in FIG. 3. Client computer 120 includes a print spooler 150, and print server 140 includes a print spooler 160. Print spooler 150 and print spooler 160 exchange print configuration and management information for client computer 120. The print spooler 160 of print server 140 controls print configuration and management and responds to requests for changes in printer settings.

As further shown in FIG. 3, print server 140 receives a printing mode selection from a user such as an administrator. The printing mode selection controls enabling and disabling of a branch office printing mode. When the branch office printing mode is enabled, print jobs are sent directly from print spooler 150 to remote printer 130. When the branch office printing mode is disabled, the print job is sent from print spooler 150 to print spooler 160 and then is sent by print spooler 160 to remote printer 130. The disabled state of the branch office printing mode may be referred to as the “normal” printing mode.

Client computer 120 receives from a user a print request to print a print job at remote printer 130. When the branch office printing mode is disabled, a print job PJ1 is sent from print spooler 150 in client computer 120 to print spooler 160 in print server 140. The print job PJ1 is then sent from print spooler 160 to remote printer 130. When the branch office printing mode is enabled, a print job PJ2 is sent directly from print spooler 150 in client computer 120 to remote printer 130. As illustrated in FIG. 3, the print job PJ2 is not sent to print server 140.

As described below, the branch office printing mode may be enabled by print server 140 on a per queue basis. Thus, different remote printers, in the same or different branch offices, may operate in different modes. Furthermore, the client computer 120 may ignore the branch office printing mode as set by print server 140 under certain circumstances, such as when the client computer 120 is incompatible with branch office printing or if conflicting printer settings are in effect.

The print spooler 150 in client computer 120 is shown in greater detail in FIG. 3A. A print job is received by local printer 170. The print data is supplied to CSR module 180, which performs rendering of the print data. The rendered data is sent directly to printer 130 in the branch office printing mode.

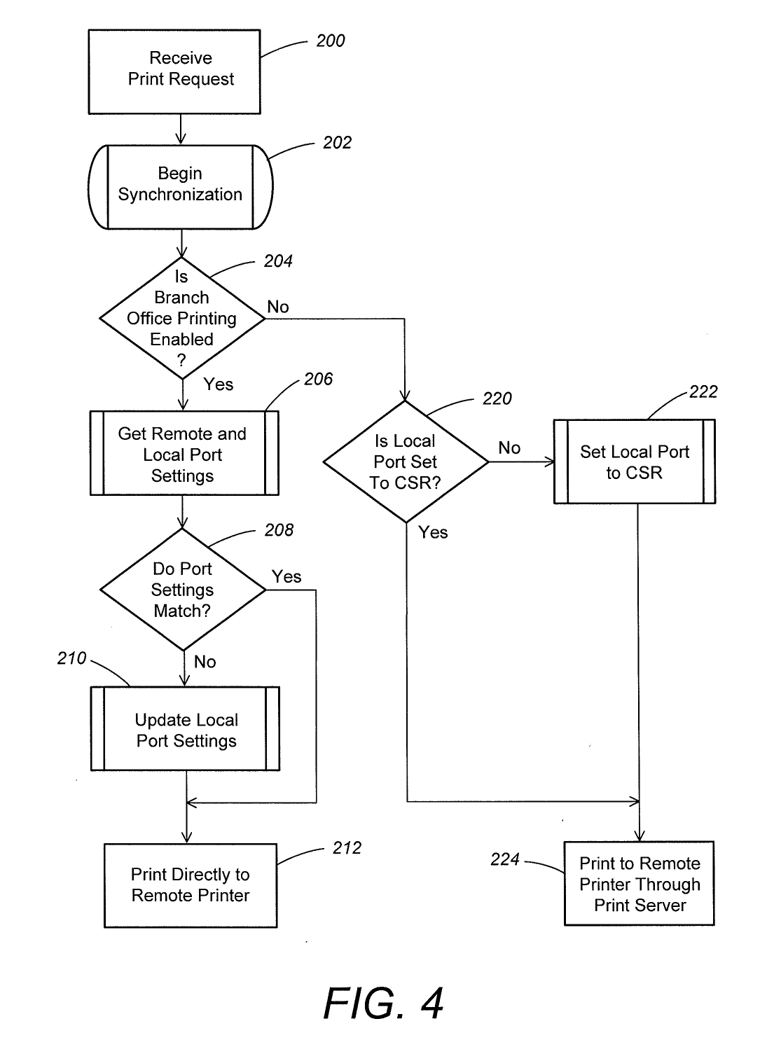

A printing process performed by client computer 120 in accordance with embodiments of the invention is shown in the flow chart of FIG. 4. Conventional acts involved in printing have been omitted from FIG. 4 in order to facilitate an understanding of the present invention. It will be understood that additional acts may be included within the printing process of the present invention. The process of FIG. 4 is described with reference to the computer system 100 shown in FIG. 3 and described above.

In act 200, client computer 120 receives a print request from a user. The print request may specify a print job to be printed by a selected printer. In many instances, the selected printer is a default printer and does not require specific selection by the user. The print job is forwarded to print spooler 150 of client computer 120. The client computer 120 begins synchronization with print server 140 in act 202. In act 204, the client computer 120 determines from print server 140 if branch office printing is enabled.

Branch office printing may utilize existing CSR (Client Side Rendering) functions in an existing print spooler software. CSR allows print job rendering to be performed by the client computer and thus allows the client computer to bypass the print server when printing. Additionally, CSR ensures that any printer driver that is compatible with CSR will be compatible with branch office printing.

Branch office printing builds on the existing Client Side Rendering functionality of the print spooler 150 in the client computer. CSR implements a remote printer connection by including a local printer (sometimes known as a “GUID printer”) that is managed by the local print spooler. The local printer is effectively a mirror of the remote printer and has the same driver, forms, settings and data as the remote printer. This allows much of the work involved in printing to a remote printer to be performed locally, on the client computer.

A difference between the local printer and the remote printer is the port. The remote printer's port is a standard one that communicates with a local (USB, LPT) port, or to a network device (for example via TCP or WSD). The local printer's port uses a CSR port monitor to communicate with the print server 140 rather than a physical printer. The CSR port monitor transmits the rendered print job from the client computer 120 to the print server 140, and the print server 140 transmits the spooled data to the actual printer.

In accordance with embodiments of the invention, the CSR port monitor on the local printer may be replaced with a “real” port monitor that can communicate with the physical printer. The port monitor settings are copied from the print server 140 and set on the local printer. Then, Client Side Rendering knows how to communicate directly to the printer without involving the print server in the printing process.

Branch office printing is configured on a per queue or per connection basis on the print server 140. In these embodiments, branch office printing is not enabled or disabled at the client computer. Configuration may be accomplished by a value set on the print server. Values set on the remote server 140 are synchronized periodically by the client computer 120, either after an elapsed time period or when changes on the print server are detected. When a variable “bypass server” is set to a non-zero value, branch office printing is enabled for the connection. However, the client computer may ignore this setting if it is incompatible with branch office printing or if conflicting settings are in effect.

Connection setup involves setting up a local printer managed by the local print spooler 150. Part of this process includes assigning a port to the printer. For both normal and branch office printing, the port defaults to the CSR port monitor. As a last step of setup, a synchronous CSR cache sync copies all the remote printer settings to the local printer. At this point, the port settings are changed from the CSR port monitor to the port settings used on the print server 140.

The Client Side Rendering function of the print spooler 150 determines how to configure a port for a connection and keeps a local printer in sync with an associated remote print queue. If the administrator changes port settings on the remote printer, they are propagated to the client computer.

The configuration of the port is based on whether the branch office printing mode is determined in act 204 to be enabled or disabled for the connection. If the branch office printing mode is enabled, and if the remote port settings differ from the local port settings, the local settings are synchronized to the remote port settings. If the branch office printing mode is disabled, then the local port settings are set to the CSR port monitor to allow normal operation of the connection. In act 220, the client computer 120, after determining that branch office printing is disabled, determines if the local port is set to CSR. If the local port is set to CSR, the process proceeds to act 224. If the local port is not set to CSR, the client computer 120 sets the local port to CSR in act 222. The process then proceeds to act 224 where the client computer 120 prints through the print server 140.

A value “Enable Branch Office Printing” determines whether branch office printing is enabled for the connection. If this value is zero or unset, then the branch office printing mode is disabled. If this value is set to a non-zero value, then the branch office printing mode is enabled, provided that no other settings conflict and the connection has not been determined to be incompatible with branch office printing.

The client computer 120 retrieves remote port settings in act 206 by making a remote data call to the print server. The type of the remote port can be determined by making the requisite data calls for TCP (Transmission Control Protocol) and WSD (Web Services for Devices) protocols. First, the client computer attempts to retrieve TCP port data, followed by WSD port data. If neither succeeds, then the port is not compatible and branch office printing mode cannot be enabled for the connection. The port is set to the CSR port monitor and the client computer reverts to normal printing. When the TCP port data is retrieved, the print server returns a data structure containing the configuration of the remote TCP port. When the WSD port data is retrieved, the print server returns a data structure containing the configuration of the remote WSD port. After the remote port settings are retrieved, the local printer current port settings are retrieved. Then, the local and remote port settings are compared. If the port settings differ, the local printer is reconfigured to use the same port settings as the print server.

If the remote port settings and the local port settings are identical, as determined in act 208, then no changes to the local port are required and synchronization is complete. The process then proceeds to act 212. If the remote and local port settings differ, as determined in act 208, then the local port settings are updated in act 210 to match the remote port settings. In addition, the associated port monitor is loaded if necessary. A new port matching the remote port is added to the local port monitor. After the new port has been added to the local port monitor, the new port can be set on the local printer, and the old port can be removed from the local port monitor. In act 212, the client computer 120 prints directly to remote printer 130.

If the remote settings from the print server 140 indicate that the branch office printing mode has been disabled for the connection or branch office printing is determined to be incompatible with the client computer 120, then a connection is configured for normal printing through the CSR port monitor. As used herein, “normal” printing refers to printing wherein the print job is sent to the remote printer through the print server.

The CSR sync manager may run in a polling mode such that it retrieves settings from the print server periodically. Since the branch office printing function uses the CSR sync manager for synchronizing port settings, there is a potential for a time window where the client computer port settings are not synchronized with the print server port settings. If the client computer were to send a print job to a branch office printer during this window, the job would fail.

To eliminate this issue, a synchronous cache sync is utilized by client computer 120 at the start of every print job. This ensures that the port settings are up to date at the time when needed. To reduce the performance impact, the synchronization function may be limited to port information, and a full printer sync may not be executed. In other embodiments, the port synchronization can be performed periodically, such as when a job is printed after a fixed time interval, instead of with every print job.

Fallback to the normal printing mode may occur under one or more of the following conditions: (1) if the remote print server is not compatible with branch office printing; (2) if the remote port settings are incompatible (non-TCP or non-WSD ports) with branch office printing; (3) if the print driver is incompatible with normal CSR operation; (4) if server side rendering has been enabled on the remote print queue; (5) if “Keep Printed Jobs” has been enabled on the remote print queue; and (6) if “Printer Pooling” is enabled on the remote print queue (i.e. the remote print queue is associated with multiple ports). When the client computer falls back to normal printing, an event may be logged explaining the reason for administrative purposes.

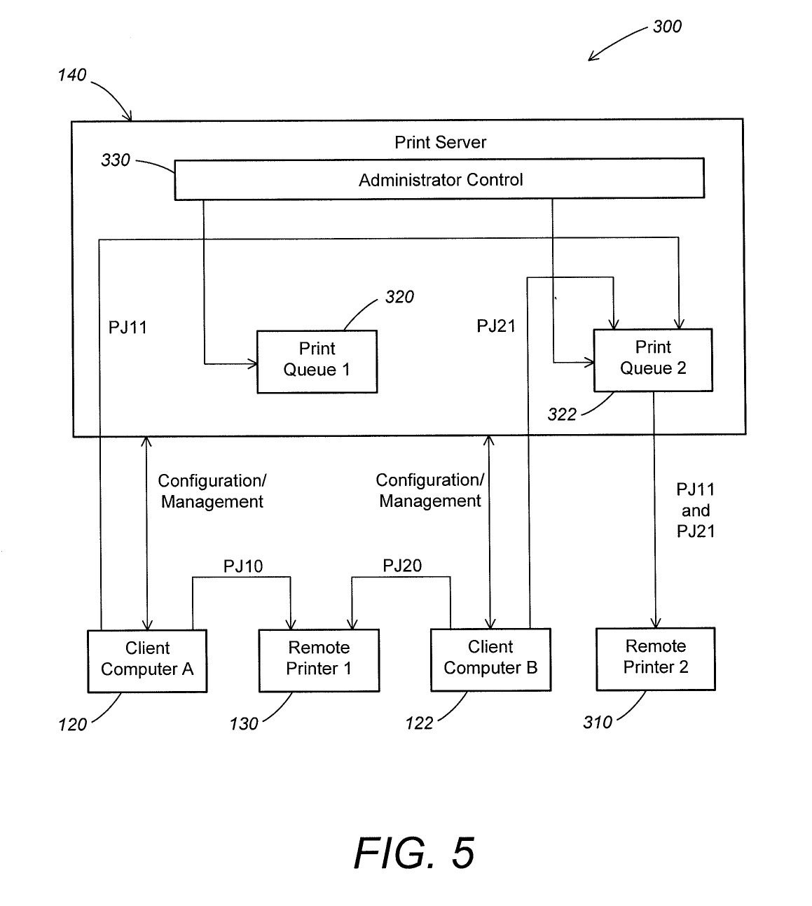

A computer system 300 in accordance with embodiments of the invention is shown in FIG. 5. The computer system 300 includes client computer 120, client computer 122, remote printer 130, remote printer 310 and print server 140. Client computers 120 and 122 and remote printers 130 and 310 may be in a branch office, and print server 140 may be in a headquarters office.

Print server 140 includes a print queue 320 for remote printer 130 and a print queue 322 for remote printer 310. It will be understood that print server 140 may include print queues for more than two remote printers. An administrator control module 330 receives inputs from an administrator and controls a printing mode of print queue 320 and print queue 322. In particular, administrator control module 330 may control whether the branch office printing mode is enabled or disabled for each of print queue 320 and 322. Print server 140 also controls configuration and management of each of client computers 120 and 122.

In the example of FIG. 5, the administrator control module 330 has enabled the branch office printing mode for remote printer 130 and has disabled the branch office printing mode for remote printer 310. It will be understood that the printing modes for each remote printer can be enabled and disabled as necessary under control by an administrator or other user. Accordingly, when client computer 120 receives a print request to print at remote printer 130, the branch office printing mode is determined from print server 140 to be enabled and a print job PJ10 is sent directly to remote printer 130, without being sent to print server 140. When client computer 120 receives a request to print to remote printer 310, the branch office printing mode is determined from print server 140 to be disabled and a print job PJ11 is sent to print queue 322 in print server 140 for forwarding from print queue 322 to remote printer 310. Similarly, when client computer 122 receives a print request to print to remote printer 130, the branch office printing mode is determined from print server 140 to be enabled. Accordingly, a print job PJ20 is sent directly from client computer 122 to remote printer 130, without being sent to print server 140. When client computer 122 receives a request to print to remote printer 310, the branch office printing mode is determined from print server 140 to be disabled, and a print job PJ21 is sent to print queue 322 for forwarding from print queue 322 to remote printer 310. It may be observed that the branch office printing mode is enabled or disabled for each printer and that each client computer prints according to the printing mode of the remote printer to be utilized.

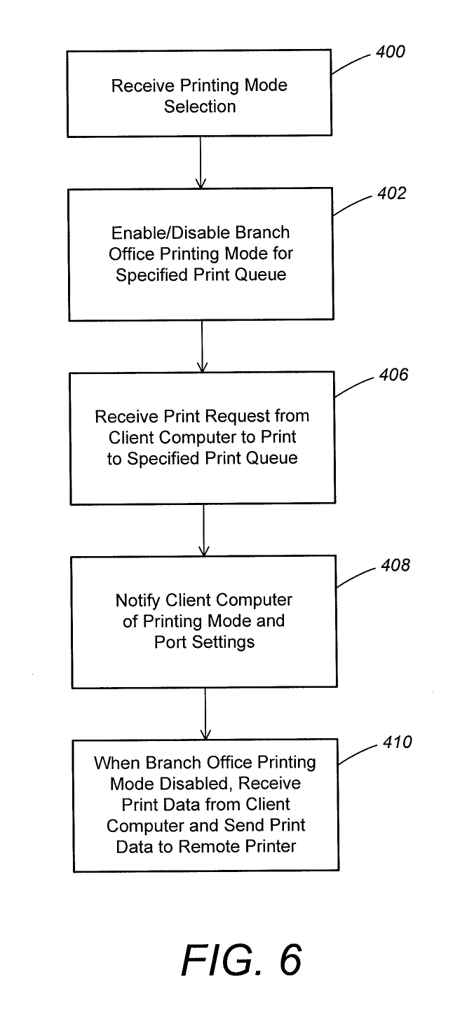

A flow chart of a process performed by print server 140 in accordance with embodiments of the invention is shown in FIG. 6. The acts involved in controlling the branch office printing mode are shown. It will be understood that the process may include additional acts within the scope of the present invention.

In act 400, the print server 140 receives a printing mode selection from an administrator or other user. The printing mode selection specifies a remote printer for which the branch office printing mode is to be enabled or disabled. It will be understood that the branch office printing mode is enabled or disabled at the print server 140 rather than at a client computer.

In act 402, the print server 140, in response to the printing mode selection received in act 402, enables or disables the branch office printing mode for a specified print queue. The print mode remains enabled or disabled until changed by an administrator.

In act 406, the print server 140 receives an indication of a print request from a client computer to print to the specified print queue.

In act 408, the print server 140 notifies the client computer of the selected printing mode and the port settings to be used in transmitting the spooled print data. In the case where the branch office printing mode is enabled, the client computer synchronizes to the port settings of the print server 140 as described above and sends the print job directly to the specified remote printer. In this case, the print server 140 does not receive the spooled print data.

In act 410, when the branch office printing mode is disabled, the print server 140 receives the spooled print data from the client computer and places the print data into the print queue for the specified remote printer. The print data is then sent from the print server 140 to the remote printer.

As described above, the print server 140 establishes the port settings of client computer 120 in both the branch office printing mode and the normal printing mode. Furthermore, the print server 140 controls print configuration and management in both the branch office printing mode and the normal printing mode. For example, the print server 140 may control printer settings and printer properties on a per queue basis. The user of a client computer can change print job settings from the default values set by the print server 140 but cannot change print queue settings. Furthermore, because the printing mode is controlled by the print server 140, the user of a client computer does not know whether branch office printing mode or normal printing mode is being utilized.

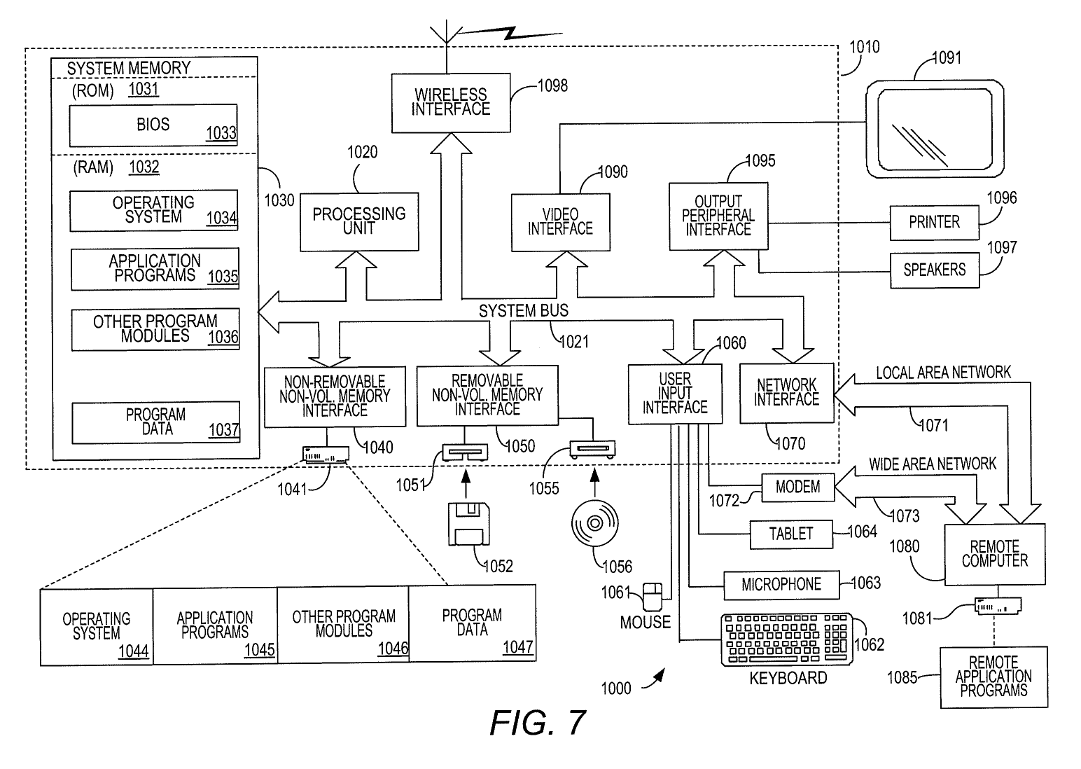

FIG. 7 illustrates an example of a suitable computing system environment 1000 on which the invention may be implemented. The computing system environment 1000 is only one example of a suitable computing environment and is not intended to suggest any limitation as to the scope of use or functionality of the invention. Neither should be computing environment 1000 be interpreted as having any dependency or requirement relating to any one or combination of components illustrated in the exemplary operating environment 1000.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of a computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communication network. In a distributed computing environment, program modules may be located in both local and remote computer storage media including memory storage devices.

With reference to FIG. 7, an exemplary system for implementing the invention includes a general purpose computing device in the form of a computer 1010. Components of computer 1010 may include, but are not limited to, a processing unit 1020, a system memory 1030, and a system bus 1021 that couples various system components including the system memory to the processing unit 1020. The system 1021, may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1010 typically includes a variety of computer readable media. Computer readable media can be any available media that can be accessed by computer 1010 and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1010. Combinations of the any of the above should also be included within the scope of computer readable storage media.

The system memory 1030 includes computer storage media in the form of volatile and/or nonvolatile memory such as read only memory (ROM) 1031 and random access memory (RAM) 1032. A basic input/output system 1033 (BIOS), containing the basic routines that help to transfer information between elements within computer 1010, such as during start-up, is typically stored in ROM 1031. RAM 1032 typically contains data and/or program modules that are immediately accessible to and/or presently being operated on by processing unit 1020. By way of example, and not limitation, FIG. 7 illustrates operating system 1034, application programs 1035, other program modules 1036, and program data 1037.

The computer 1010 may also include other removable/non-removable volatile/nonvolatile computer storage media. By way of example only, FIG. 7 illustrates a hard disk drive 1040 that reads from or write to non-removable, nonvolatile magnetic media, a magnetic disk drive 1051 that reads from or writes to a removable, nonvolatile magnetic disk 1052, and an optical disk drive 1055 that reads from or writes to a removable, nonvolatile optical disk 1056 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1041 is typically connected to the system bus 1021 through a non-removable memory interface such as interface 1040, and magnetic disk drive 1051 and optical disk drive 1055 are typically connected to the system bus 1021 by a removable memory interface, such as interface 1050.

The drives and their associated computer storage media, discussed above and illustrated in FIG. 7, provide storage of computer readable instructions, data structures, program modules and other data for the computer 1010. In FIG. 7, for example, hard disk drive 1041 is illustrated as storing operating system 1044, application programs 1045, other program modules 1046, and program data 1047. Note that these components can either be the same as or different from operating system 1034, application programs 1035, other program modules 1036, and program data 1037. Operating system 1044, application programs 1045, other program modules 1046, and program data 1047 are given different numbers here to illustrate that, at a minimum, they are different copies.

A user may enter commands and information into the computer 1010 through input devices such as a keyboard 1062 and pointing device 1061, commonly referred to as a mouse, trackball or touch pad. Other input devices may include a microphone 1063, joystick, a tablet 1064, satellite dish, scanner, or the like. These and other input devices are often connected to the processing unit 1020 through a user input interface 1060 that is coupled to the system bus, but may not be connected by other interface and bus structures, such as a parallel port, game port or a universal serial bus (USB). A monitor 1091 or other type of display device is also connected to the system 1021 via an interface, such as a video interface 1090. In addition to the monitor, computers may also include other peripheral output devices such as speakers 1097 and printer 1096, which may be connected through a output peripheral interface 1095.

The computer 1010 may operate in a networked environment using logical connections to one or more remote computers, such as a remote computer 1080. The remote computer 1080 may be a personal computer, a server, a router, a network PC, a peer device or other common network node, and typically includes many or all of the elements described above relative to the computer 1010, although only a memory storage device 1081 has been illustrated in FIG. 7. The logical connections depicted in FIG. 7 include a local area network (LAN) 1071 and a wide area network (WAN) 1073 and a wireless link, for example via a wireless interface 1098 complete with an antenna, but may also include other networks. Such networking environments are commonplace in offices, enterprise-wide computer networks, intranets and the Internet. While wireless interface 1098 is shown directly connected to system bus 1021, it is recognized that the wireless interface 1098 may be connected to system bus 1021 via network interface 1070.

When used in a LAN networking environment, the computer 1010 is connected to the LAN 1071 through a network interface or adapter 1070. When used in a WAN networking environment, the computer 1010 typically includes a modem 1072 or other means for establishing communications over the WAN 1073, such as the Internet. The modem 1072, which may be internal or external, may be connected to the system bus 1021 via the user input interface 1060, or other appropriate mechanism. In a networked environment, program modules depicted relative to the computer 1010, or portions thereof, may be stored in the remote memory storage device. By way of example, and not limitation, FIG. 7 illustrates remote application programs 1085 as residing on memory device 1081. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable storage medium or media can be transportable, such that the program or programs stored thereon can be loaded onto one or more different computers or other processors to implement various aspects of the present invention as discussed above. As used herein, the term “non-transitory computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for printing by a client computer, comprising:
receiving, by a client computer from a user, a print request;
determining, by the client computer from a print server, if a branch office printing mode is enabled;
if the branch office printing mode is determined to be enabled, the client computer executing the print request by printing directly to a selected printer; and
if the branch office printing mode is determined to be disabled, the client computer executing the print request by printing to the selected printer through the print server.

2. A method as defined in claim 1, further comprising, if the branch office printing mode is enabled, synchronizing printer settings of the client computer and the print server.

3. A method as defined in claim 2, wherein synchronizing printer settings comprises:
determining if client computer settings and print server settings match,
if the client computer and print server settings match, proceeding with printing directly to the selected printer, and
if the client computer and print server settings do not match, updating the client computer settings to match the print server settings and proceeding with printing directly to the selected printer.

4. A method as defined in claim 3, wherein the client computer settings include port settings.

5. A method as defined in claim 1, wherein proceeding with printing directly comprises sending print data to the selected printer without sending the print data to the print server.

6. A method as defined in claim 1, further comprising receiving printer settings from the print server for use in the branch office printing mode.

7. A method as defined in claim 1, wherein the branch office printing mode is enabled or disabled for each print queue of the print server.

8. A method as defined in claim 1, further comprising, if the branch office printing mode is determined to be enabled, the client computer automatically falling back, in response to detecting at least one condition, to a normal printing mode wherein the branch office printing mode is disabled.

9. A computer-readable storage medium encoded with computer-executable instructions that, when executed by a computing device, perform the method of claim 1.

10. A client computer configured to execute a print request, comprising:
a processor and a memory device, the memory device including:
a print spooler to hold print data, to receive a print request, to determine from a print server if a branch office printing mode is enabled, if the branch office printing mode is determined to be enabled, to proceed with printing by sending the print data directly to a selected printer, and if the branch office printing mode is determined to be disabled, to proceed with printing by sending the print data to the selected printer through the print server.

11. A client computer as defined in claim 10, wherein the print spooler is configured, if the branch office printing mode is enabled, to synchronize printer settings of the client computer and the print server.

12. A client computer as defined in claim 11, wherein the print spooler is configured to synchronize printer settings by:
determining if client computer settings and print server settings match,
if the client computer and print server settings match, proceeding with printing directly to the selected printer, and
if the client computer and print server settings do not match, updating the client computer settings to match the print server settings and proceeding with printing directly to the selected printer.

13. A client computer as defined in claim 12, wherein the client computer settings include port settings.

14. A client computer as defined in claim 10, wherein the print spooler is configured to receive printer settings from the print server for use in the branch office printing mode.

15. A method for controlling printing by a print server, comprising:
receiving, by a print server from an administrator, a branch office printing mode selection for a specified print queue;
enabling, by the print server, the branch office printing mode for the specified print queue;
receiving, by the print server, an indication of a print request from a client computer; and
notifying, by the print server, the client computer that the branch office printing mode is enabled.

16. A method as defined in claim 15, further comprising, if the branch office printing mode is enabled, providing printer settings to the client computer for synchronization by the client computer.

17. A method as defined in claim 16, wherein the printer settings include port settings.

18. A method as defined in claim 15, further comprising sending printer settings to the client computer for use in the branch office printing mode.

19. A method as defined in claim 15, wherein the print server includes two or more print queues, further comprising individually enabling or disabling the branch office printing mode for each of the print queues in accordance with commands received from an administrator.

20. A computer-readable storage medium encoded with computer-executable instructions that, when executed by a computing device, perform the method of claim 15.
